(19) United States
(12) Patent Application Publication
(10) Pub. No.: US 2007/0028279 A1
(43) Pub. Date: Feb. 1, 2007

(54) SYSTEM FOR PERSONAL VIDEO BROADCASTING AND SERVICE METHOD USING INTERNET

(75) Inventor: Kyung Ik Kim, Anyang-si (KR)

Correspondence Address: BOOTH UDALL, PLC, 1423 S. HIGLEY ROAD, SUITE 110, MESA, AZ, 85206, US

(73) Assignee: PANDORATV CO., LTD., Seoul (KR)

(21) Appl. No.: 11/459,894

(22) Filed: Jul. 25, 2006

(30) Foreign Application Priority Data
Aug. 1, 2005 (KR) 10-2005-0070333

(51) Int. Cl. H04N 7/173; G06F 3/00; G06F 13/00; H04N 5/445

(52) U.S. Cl. 725/113; 725/58; 725/112; 725/87

(57) ABSTRACT

Disclosed herein are a personal video broadcast system and service method using the Internet. The system utilizes a terminal for viewing that connects to a web site and allows the user to watch personal video broadcasts and Video On Demand (VOD) in real time. Wired and wireless Internet operates to connect the user's viewing terminal to a web server that provides channel, live broadcast, and VOD information through the web pages of the web site in real time. A media server operates in conjunction with the web server, and performs real time video encoding and conversion of the channel, live broadcast, and VOD information into a format viewable in the environment of the terminal. A user's terminal for broadcasting operates in conjunction with the media server which transmits the video information. A video device also connects to the user's terminal for broadcasting which captures video images.

### BACKGROUND OF THE INVENTION

1. Field of the Invention

The present invention relates, in general, to a personal video broadcast system and service method using the Internet, and more particularly, to a technology that establishes a media portal tool for providing channels, live broadcasts, and video on demand, which are capable of being personalized and commercialized on-line, and provides personal video broadcasts via the Internet in a one-stop fashion.

2. Description of the Related Art

Recently, as the number of personal Internet broadcasting stations, such as music broadcasting stations, which have been established by individual users, rather than by specialized companies, has increased rapidly, personal Internet broadcasting is becoming established as a culture for expressing individual personalities.

However, conventional personal Internet music broadcasting merely provides simple audio music broadcasts or video chatting-level broadcasts that deliver basic images, input to a camera, as they are. As the number of users increases, demand for a low-priced tool, which can support personal editing and provide broadcast content capable of meeting various demands using various pieces of content without requiring high-priced specialized equipment or trained persons, is gradually increasing.

For Internet broadcasting, which is provided by an educational institution or various institutions and is oriented toward most of the public, as well as for personal Internet broadcasting by individual users, high-priced specialized equipment and trained persons are required in practice in order to provide high-quality broadcast content using various multimedia technologies, such as virtual reality technology.

Furthermore, in order to share video files via the Internet, it is necessary for individuals to connect to a media server and perform registration using additional software, such as File Transfer Protocol (FTP) software, which is difficult to handle. This is difficult technical work that untrained persons cannot easily handle, but experts can.

Meanwhile, customers' desire to store and manage videos, which are captured by rapidly popularized digital or mobile phone cameras, in specific storages, and to allow other people to easily view them, is increasing day by day, but functions capable of meeting the customers' demands are wholly lacking.

Accordingly, a popular tool is desireable that can provide content like specialized broadcasting stations via the previously popularized wired and wireless Internet network by personally performing live broadcasting and also broadcasting captured videos in a Video On Demand (VOD) fashion using popular devices, such as a Personal Computer (PC) camera, a digital camera and various video capture boards without requiring specialized training.

### SUMMARY OF THE INVENTION

Accordingly, the present invention has been made keeping in mind the above problems occurring in the prior art, and an object of the present invention is to provide a personal video broadcast system and service method using the Internet, which establishes a media portal tool for providing channels (personal media field), live broadcasts (Internet live broadcasting field) and VOD (streaming field, such as music, movies and personal videos), which are capable of being personalized and commercialized on-line, and provides personal video broadcasts via the Internet in a one-stop fashion.

In order to accomplish the above object, the present invention provides a personal video broadcast system, including:

a user's terminal for viewing for connecting to a web site, and allowing the user to watch personal video broadcasts and VOD in real time;

a wired and wireless Internet for operating in conjunction with the user's terminal for viewing;

a web server for operating in conjunction with the Internet, and providing the information of channels, live broadcasts, and VOD through the web pages of the web site in real time;

a media server for operating in conjunction with the web server, and converting the information of channel, live broadcasts, and VOD into a format in the environment of the terminal;

a user's terminal for broadcasting for operating in conjunction with the media server, performing real-time encoding or selecting a desired one of broadcasts in real time, and transmitting various pieces of information; and

a video device for connecting to the user's terminal for broadcasting and capturing video images.

In addition, the present invention provides a personal video broadcast service method, including the steps of:

registering as a free member of a personal video broadcasting site via a user's terminal for broadcasting that connects to the Internet;

moving to a channel, that is, a personal Internet broadcasting space, when membership authentication is made through a login and membership authentication process;

selecting live broadcasts after the movement to the personal channel;

determining whether a broadcasting program has been installed after the selection of the live broadcast;

automatically searching for a desired video/audio capture device and selecting the video/audio capture device, if, as a result of the determination, it is determined that the broadcasting program has been installed;

inputting basic broadcasting information about a title, video quality, a viewing grade and links after the selection, thus completing the preparation of a broadcasting system; and

creating a unique Uniform Resource Locator (URL) for broadcasting and connecting to a media server after the completion of the preparation of the broadcasting system, thus starting broadcasting through image compression and data transmission in real time.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a personal video broadcast system;

FIG. 2 is a flowchart illustrating a live broadcasting process of the personal video broadcast system according to the present invention;

FIG. 3 is a flowchart illustrating a VOD encoding/playback process of the personal video broadcast system according to the present invention;

FIG. 4 is a picture illustrating a VOD encoding process according to an embodiment of the present invention;

FIG. 5 is a picture illustrating a VOD payment function according to an embodiment of the present invention; and

FIG. 6 is a picture illustrating a process of purchasing a live super viewer item according to an embodiment of the present invention.

### DESCRIPTION OF THE PREFERRED EMBODIMENTS

The constructions and operations of embodiments of the present invention are described in detail with reference to the accompanying drawings below.

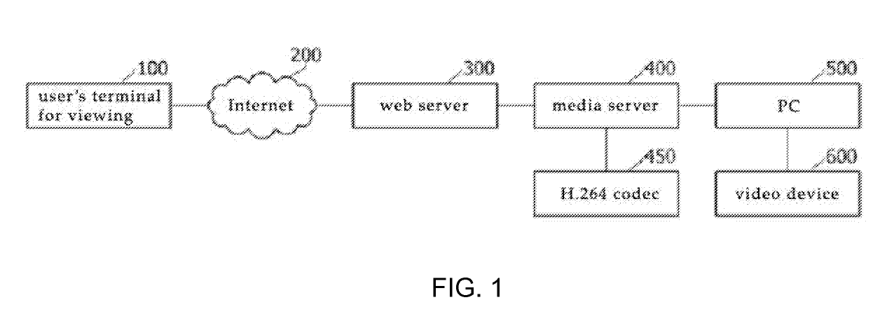

FIG. 1 is a block diagram showing the construction of a personal video broadcast system.

Referring to FIG. 1, the personal video broadcast system includes a user's terminal for viewing 100, the Internet 200, a web server 300, a media server 400, an H.264 codec 450, a user's terminal for broadcasting 500, and a video device 600.

The user's terminal for viewing 100 is a communication terminal device that connects to a web site, and enables the real-time viewing of various pieces of personal video broadcast and VOD content. Furthermore, the user's terminal for viewing 100 may be a communication terminal, such as a notebook, a PC, a Personal Digital Assistant (PDA), an MPEG Layer-3 (MP3) player, and a Portable Multimedia Player (PMP), which can set up a wired and wireless Internet connection. The user's terminal for viewing 100 and the user's terminal for broadcasting 500 may be the same device, according to manufacturer's Internet connection setting.

The Internet 200 functions as a communication interface between the user's terminal for viewing 100, the user's terminal for broadcasting 500 and the web server 300. For this purpose, a wired and wireless network may be used. The Internet 200 may include all wired and wireless Internets, such as Wireless Broadband (WiBro) and High-Speed Downlink Packet Access (HSDPA), as well as the existing wired Internet.

The web server 300 is a driving application for operating in conjunction with a DataBase (DB), and functions to provide the information of channels, live broadcasts and VOD through the web page of the web site in real time.

The media server 400 is a video media solution conversion server, operates in conjunction with the web server 300 and various video codecs, including an H.264 codec 450, performs conversion on the information of channels, live broadcasts and VOD into a format in the environment of the user's terminal for viewing 100, and provides the results obtained through the conversion.

That is, for the VOD, codecs for respective video media solutions differ from each other, so that the user's terminal for broadcasting 500 functions to perform encoding to load a personal video onto the media server 400 and play it back in real time.

The H.264 codec 450 used for the present invention is based on a protocol for operating in conjunction with the media server 400 and providing a basic video format, and is compatible with a Digital Multimedia Broadcasting (DMB) format, that is, the next-generation broadcasting format. If videos are transmitted using a heterogeneous codec, compatibility can be achieved through conversion.

The user's terminal for broadcasting 500, such as a PC, indicates a terminal for operating in conjunction with the media server 400 and performing encoding in real time or select broadcasts in real time, thereby transmitting various pieces of information. The video device 600 is connected to the user's terminal for broadcasting 500, such as a PC, and may include all of the video input devices, such as a PC camera, a camcorder, a digital camera and a TV receiving card, which are capable of capturing moving images (video and audio) or still images. Furthermore, a mobile phone, an MPEG Layer-3 Player (MP3P), a PMP, a DMB, or an Internet Protocol-TeleVision (IP-TV), which can perform both bidirectional communication and camera functions, may also function as both the user's terminal 500 for personal broadcasting and the video device 600.

The personal video broadcast system is implemented based on the establishment of a media portal tool for providing channels (personal media field), live broadcasts (Internet broadcasting field) and VOD (streaming field, such as music), which can be personalized and commercialized.

That is, the channels provide a personal video TV blog service and a Business Information Zone (BIZ) type brand channel service, and the live broadcasts provide a personal broadcasting communication service, a TV relay broadcasting service, a live relay broadcasting service, and a one-person broadcasting service. The VOD provides a BIZ type VOD streaming service and affiliated services, such as music, movies, adult content, and animation sevices.

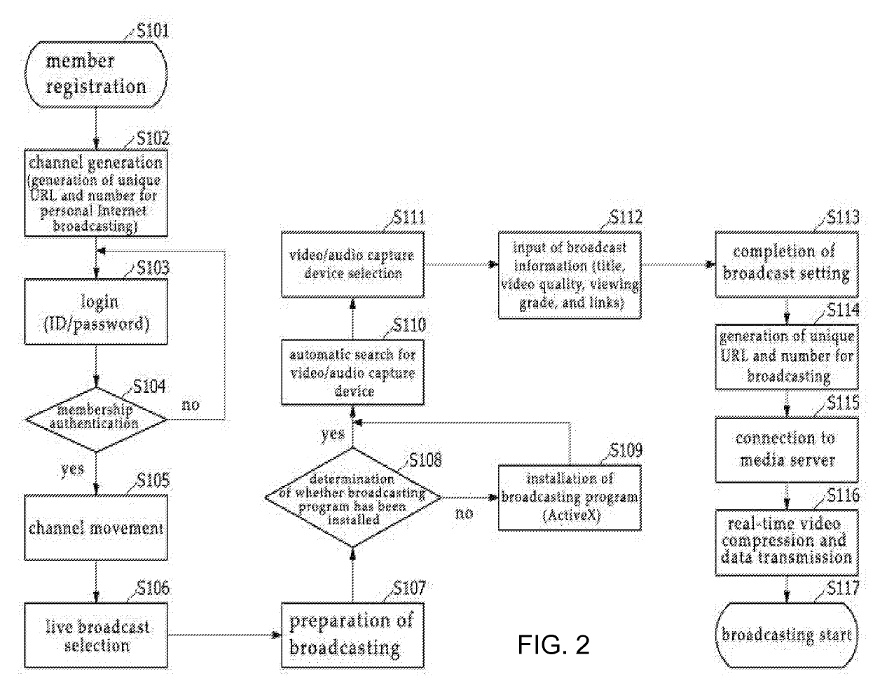

FIG. 2 is a flowchart illustrating a live broadcasting process of the system for providing personal video broadcast service according to the present invention.

The live broadcasting according to the present invention enables Internet on-the-spot relay broadcasting to be performed through the user's terminal for broadcasting 500, which operates in conjunction with the video device 600, in an environment in which the wired and wireless Internet 200 can be used.

First, a user registers as a free member of a personal video broadcasting site via the user's terminal for broadcasting 500 connected to the Internet 200 at step S101 as shown in FIG. 2. In this case, a member registration process is a well-known technology, and basic information about an IDentifier (ID), a password, a resident registration number, a contact phone number and an address are input.

In this case, when the member registration is completed, a unique member channel (a personal Internet broadcasting space, and the URL and unique number of the channel) is automatically created at step S102.

Thereafter, login is performed by inputting the ID and the password at step S103. When the user is authenticated as a membership through a membership authentication process, movement to the personal channel, that is, an Internet broadcasting space, is performed at step S104.

After the movement to the personal channel has been performed at S105, a live broadcasting menu item is selected at step S106. By doing so, live broadcasting is placed in a standby state, and the video device 600 of the user's terminal for broadcasting 500 is automatically searched at step S107.

That is, whether a broadcasting program has been installed is determined at step S108. If a broadcasting program has not been installed, the broadcasting program in the form of, for example, an “ActiveX” control, is installed at step S109. If a broadcasting program has been installed, video and audio capture devices are automatically searched for at step S110.

Thereafter, a video and audio capture device is selected by the user at step S111. That is, either a low-quality or high-quality video is selected. Thereafter, basic broadcasting information about a title, video quality, a viewing grade, and links is input at step S112, so that preparation for starting broadcasting is completed at step S113.

After the completion of the preparation for starting broadcasting, a unique URL and a unique number, which will be used for broadcasting, are created at step S114. Thereafter, a connection to the media server 400 is set up at step S115, so that the broadcasting is started by the real-time transmission of video compression data at step S116.

In this case, the data transmission for the broadcast S117 may be achieved using a multiple path stream data transmission technology based on Transmission Control Protocol (TCP).

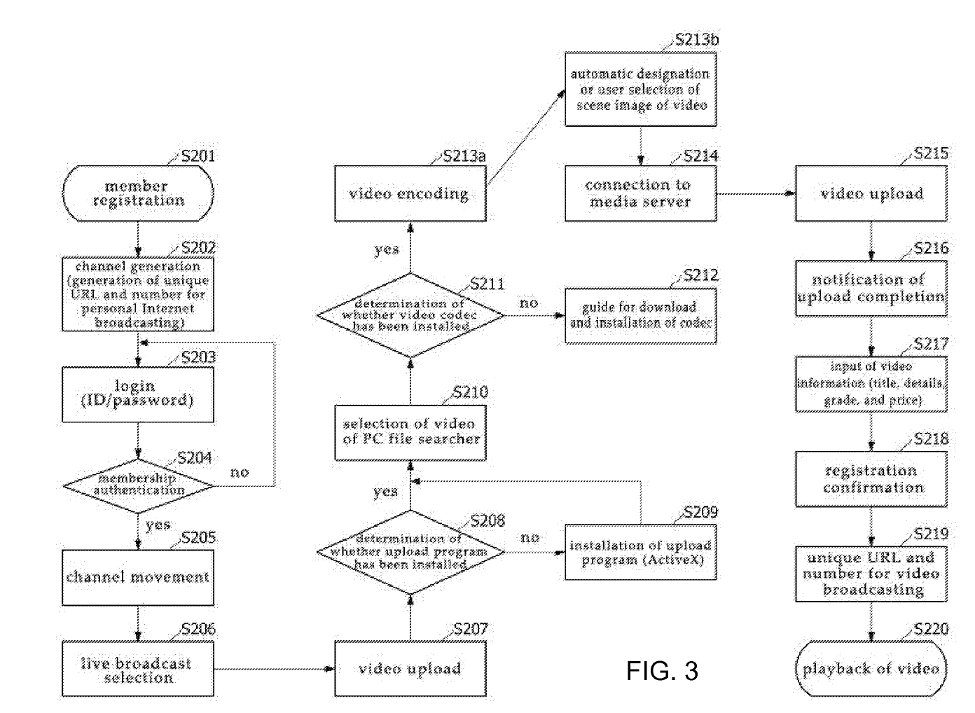

FIG. 3 is a flowchart illustrating a VOD encoding/playback process of the system for providing personal video broadcast service according to the present invention.

The concept of real-time VOD encoding/playback in the present invention relates to real-time conversion and uploading to the media server 400 regardless of the video format, thereby enabling playback in various video playback software environments of the user's terminal for viewing 100.

First, the user registers on a personal video broadcasting site as a free member via the user's terminal for broadcasting 500 connected to the Internet 200 at step S201. In this case, a member registration process is a well-known technology, and basic information about an ID, a password, a resident registration number, a contact phone number and an address is input.

In this case, when the member registration is completed, a unique member channel (a personal Internet broadcasting space, and the unique URL and number of the channel) are automatically created at step S202.

Thereafter, login is performed by inputting the ID and the password at step S203. In the case where the user is authenticated as a membership through a membership authentication process at step 204, movement to a personal channel, that is, an Internet broadcasting space, is performed at step S205.

After the movement to the personal channel has been performed, a desired broadcasting program is selected and a video upload menu item is clicked at step S206. Consequently, corresponding video information is uploaded at step S207, and a determination of whether an upload program has been installed is made at step S208.

If the upload program has not been installed, an upload program in the form of, for example, an “ActiveX” control is automatically installed at step S209. In contrast, if the upload program has been installed, the video of a PC file searcher is selected at step S210.

Thereafter, the media server 400 determines whether a video codec has been installed at step S211. If the video codec has not been installed, a guide for the download and installation of the codec is provided at step S212.

If the video codec has been installed, the video is encoded and the scene image of the video is automatically designated or selected by the user. During or after encoding a connection to the media server 400 is set up, at S213a to S214.

Thereafter, the selected video is uploaded at step S215. After the completion of the uploading, notification of the fact that the uploading has been completed is provided at step S216. Thereafter, basic broadcasting information about a title, details, a viewing grade and a price is input and then the registration is confirmed, at steps S217 to S218.

After the completion of the registration confirmation, a unique URL and a unique number, which will be used for broadcasting, are created at step S219. A connection to the media server 400 is set up and the video is played back in real time at step S220.

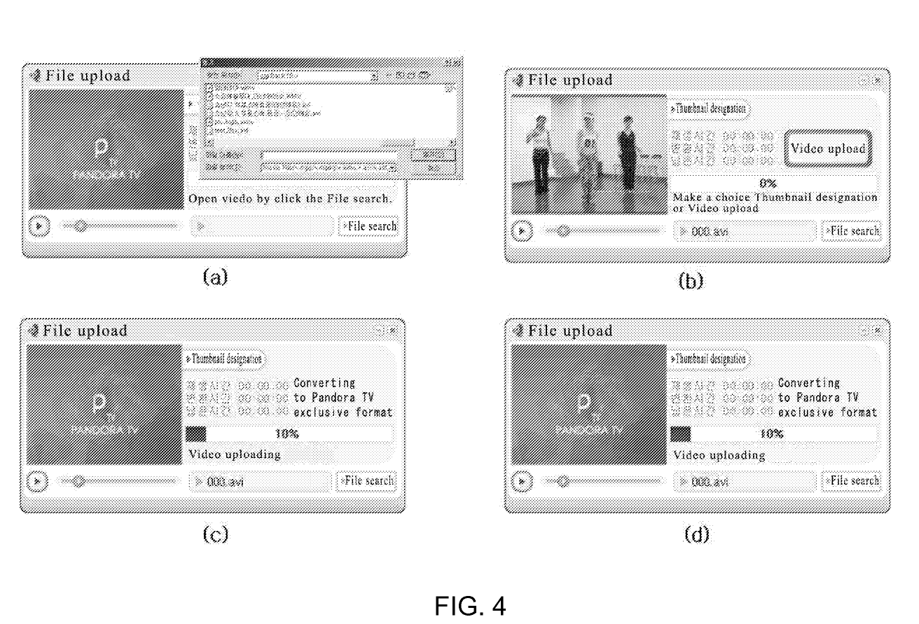

The real-time VOD encoding process described above is described in more detail with reference to FIG. 4.

With reference to FIG. 4A, when a user clicks a file search menu item and then selects video, an open dialogue box is opened. With reference to FIG. 4B, the open image is automatically played back. During playback, when “thumbnail designation” is clicked, the video scene on a corresponding screen is instantaneously captured and stored.

With reference to FIG. 4C, a file is converted into a dedicated format appropriate to a user environment. With reference to FIG. 4D, the video file and the thumbnail, which are encoded by the media server 400, are uploaded and the real-time VOD encoding process is completed.

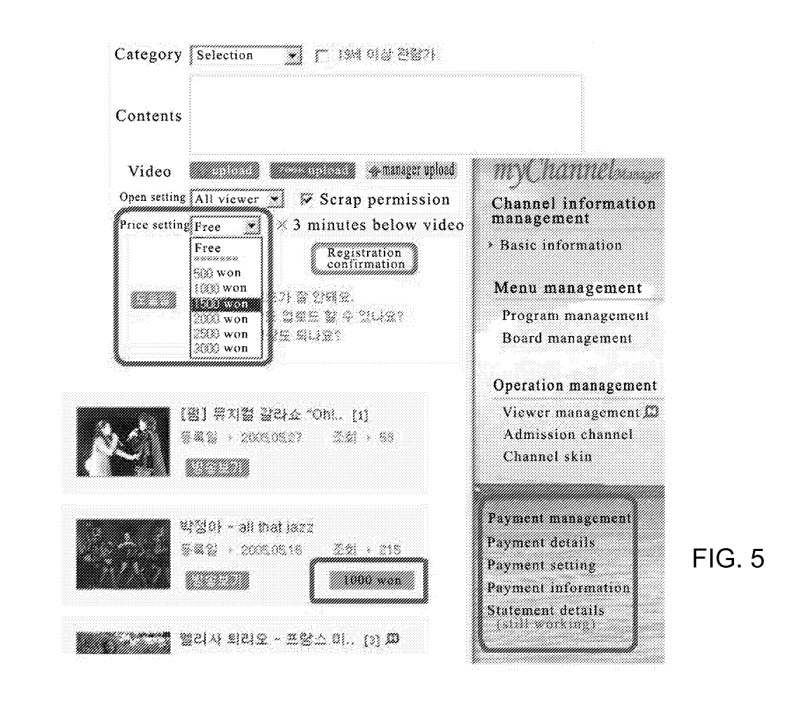

FIG. 5 is a picture illustrating a VOD payment function according to an embodiment of the present invention, and shows a digital market function through which personal videos can be sold.

In the present embodiment, a method of uploading videos is the same as in the real-time VOD encoding process, so that a description thereof is omitted.

A description of the VOD payment function shown in FIG. 5 is given below. First, the user selects a desired price on a price setting area and then clicks a registration confirmation menu item.

In this case, VOD, the price of which is set, is indicated as “charged” in a list, and the charged VOD can be viewed for twenty seconds using a preview function. Thereafter, the details of payment can be checked through a channel information management menu.

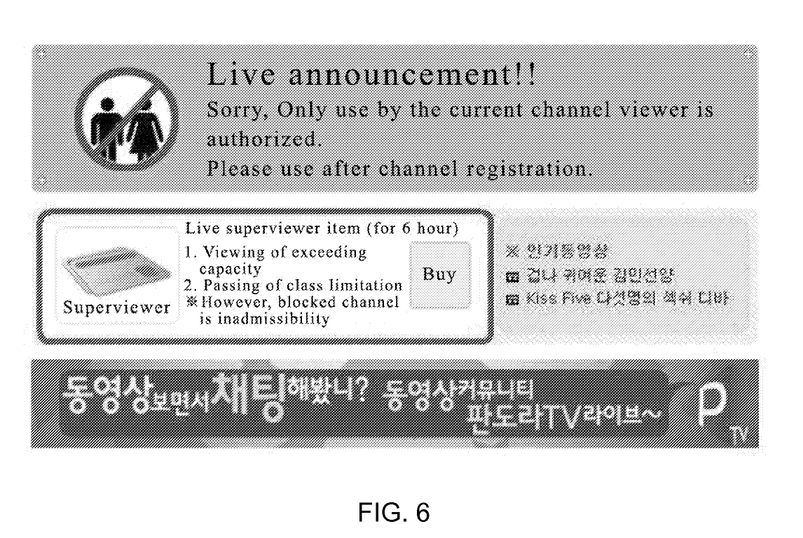

FIG. 6 is a picture illustrating a process of purchasing a live super viewer item according to an embodiment of the present invention.

First, a channel of providing a live broadcasting service is clicked. In this case, a message indicating viewer restriction is indicated.

Thereafter, the user clicks a menu item for purchasing an item called “live superviewer,” and makes a payment for the selected item. Thereafter, if the user clicks again on the channel, the selected broadcast can now be viewed.

As described above, the present invention establishes a media portal tool for providing channels (personal media field), live broadcasts (Internet live broadcasting field) and VOD (streaming field, such as music, movies and personal videos), which are capable of being personalized and commercialized on-line, and provides real-time personal video broadcasts via the Internet in a one-step fashion. Accordingly, the present invention has the following advantages:

First, from the point of view of personal broadcasters, free channels are provided in differentiated pop-up form, so that personal desire to store and show broadcasts and videos can be satisfied. That is, a one-person digital Internet broadcast station, memorial album, compilation album or the like can be made.

Second, from the point of view of personal viewers and business users, personalized personal content, which is made by the one-person digital Internet broadcasting station, can be appreciated and purchased. A business can not only considerably reduce advertisement costs, which were previously paid to a terrestrial wave broadcasting station and a portal site, by directly managing a broadcasting station for advertising its new products or brands, but can also manage a BIZ type broadcasting station capable of maximizing the degree of knowledge of its products and brands.

Third, in Korea, Japan, and the United States of America, in which the popularization rate of the Internet is high, a very productive one-person media market, in which existing pictures and text-based media are converted into videos using the present invention or a large amount of video content kept is distributed and transferred to customers, can be formed.

Fourth, recently, the convergence market is emerging thanks to a combination of wired and wireless Internets, combinations of various personal portable terminals, and combinations of personal portable terminals and the wireless Internet, so that the customers are no longer mere customers, and can play the role of producers of media using the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A personal video broadcast system, comprising:
a user's terminal for viewing for connecting to a web site, and allowing the user to watch personal video broadcasts and Video On Demand (VOD) in real time;
a wired and wireless Internet for operating in conjunction with the user's terminal for viewing;
a web server for operating in conjunction with an Internet, and providing information of channels, live broadcasts, and VOD through web pages of the web site in real time;
a media server for operating in conjunction with the web server, and converting the information of channel, live broadcasts, and VOD into a format in an environment of the terminal;
a user's terminal for broadcasting for operating in conjunction with the media server, performing real-time encoding or selecting a desired one of broadcasts in real time, and transmitting various pieces of information; and
a video device for connecting to the user's terminal for broadcasting and capturing video images.

2. The system as set forth in claim 1, wherein the user's terminal for viewing comprises a communication terminal, such as a notebook, a Personal Computer (PC), a Personal Digital Assistant (PDA), an MPEG Layer-3 player (MP3P) or a mobile phone, which can set up an Internet connection.

3. The system as set forth in claim 1, wherein the media server is based on a protocol for operating in conjunction with a video codec and providing a basic video format.

4. The system as set forth in claim 1, wherein the channels provide a personal video TeleVision (TV) blog service and a Business Information Zone (BIZ) type brand channel service.

5. The system as set forth in claim 1, wherein the live broadcasts provide a personal broadcasting communication service, a TV relay service, and a one-person broadcasting service.

6. The system as set forth in claim 1, wherein the VOD provides a BIZ type VOD streaming service and affiliated services, such as music, movie, adult content, and animation services.

7. A personal video broadcast service method, comprising the steps of:
registering as a free member of a personal video broadcasting site via a user's terminal for broadcasting that connects to an Internet;
moving to a channel, that is, a personal Internet broadcasting space, when membership authentication is made through a login and membership authentication process;
selecting live broadcasts after the movement to the personal channel;
determining whether a broadcasting program has been installed after the selection of the live broadcast;
automatically searching for a desired video/audio capture device and selecting the video/audio capture device, if, as a result of the determination, it is determined that the broadcasting program has been installed;
inputting basic broadcasting information about a title, video quality, a viewing grade and links after the selection, thus completing preparation of a broadcasting system; and
creating a unique Uniform Resource Locator (URL) for broadcasting and connecting to a media server after the completion of the preparation of the broadcasting system, thus starting broadcasting through image compression and data transmission in real time.

8. The method as set forth in claim 7, wherein, when the registration as a member is made, a unique member channel (a personal Internet broadcasting space and a unique channel number) is automatically created.

9. The method as set forth in claim 7, wherein the transmitting the image compression data in real time is achieved by using multiple path stream data transmission based on Transmission Control Protocol (TCP).

10. A personal video broadcast service method for implementing a VOD encoding/playback process in real time, the method comprising the steps of;
registering as a free member of a personal video broadcasting site via a user's terminal for broadcasting that connects to an Internet;
moving to a channel, that is, a personal Internet broadcasting space, when membership authentication is made through a login and membership authentication process;
selecting a broadcasting program and uploading video information after the movement to the personal channel;
determining that the upload program has been installed, and then selecting video of a PC file searcher if it is determined that the program has been installed;
performing search to determine whether a video codec has been installed, receiving a guide for download and installation of the codec if it is determined that the video codec has not been installed, and performing a video encoding process and connecting to a media server if it is determined that the video codec has been installed;
inputting basic broadcasting information about a title, details, a viewing grade and a price, and confirming the registration, after the completion of the upload of the video and creating a unique URL for broadcasting and connecting to the media server, thus playing back the video in real time.

11. The method as set forth in claim 10, wherein when the member registration is made, a unique member channel (a personal Internet broadcasting space and a unique channel number) is automatically created.
